(19) United States
(12) Patent Application Publication
(10) Pub. No.: US 2022/0100756 A1
(43) Pub. Date: Mar. 31, 2022

(54) NAVIGATION AGENT FOR A SEARCH INTERFACE

(71) Applicant: Microsoft Technology Licensing, LLC, Redmond, WA (US)

(72) Inventors: PRAVEEN KUMAR BODIGUTLA, Santa Clara, CA (US); BEE-CHUNG CHEN, San Jose, CA (US); BO LONG, Palo Alto, CA (US); MIAO CHENG, Sunnyvale, CA (US); QIANG XIAO, Palo Alto, CA (US); TANVI SUDARSHAN MOTWANI, Redmond, WA (US); WENXIANG CHEN, Redmond, WA (US); SAI KRISHNA BOLLAM, Sunnyvale, CA (US)

(21) Appl. No.: 17/038,901

(22) Filed: Sep. 30, 2020

(51) Int. Cl. G06F 16/2452; G06F 16/248; G06N 3/08

(52) U.S. Cl. CPC G06F 16/24522; G06N 3/0445; G06N 3/08; G06F 16/248

(57) ABSTRACT

The disclosed technologies include a navigation agent for a search interface. In an embodiment, the navigation agent uses reinforcement learning to dynamically generate and select navigation options for presentation to a user during a search session. The navigation agent selects navigation options based on reward scores, which are computed using implicit and/or explicit user feedback received in response to presentations of navigation options.

### TECHNICAL FIELD

A technical field to which the present disclosure relates is graphical user interface navigation for creating and executing search queries.

### BACKGROUND

Many search engines allow natural language searching. Search engines may supplement the natural language search capability by providing filters and/or suggested search alternatives. However, search suggestions and filters provided by existing approaches often perform no better than the user's original query and it still may take several iterations for the search engine to finally retrieve the desired search results. In existing systems, filters are static, meaning that the same filters are always provided regardless of the contents of the user's search.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram illustrating at least one embodiment of a computing system in which aspects of the present disclosure may be implemented.

FIG. 2A is a flow diagram of a process that may be used to implement a portion of the computing system of FIG. 1.

FIG. 2B is a flow diagram of a process that may be used to implement a portion of the computing system of FIG. 1.

FIG. 2C is a schematic diagram of a reinforcement learning-based software agent that may be used to implement a portion of the computing system of FIG. 1.

FIG. 2D and FIG. 2E are schematic diagrams of portions of a reinforcement learning-based software agent that may be used to implement a portion of the computing system of FIG. 1.

FIG. 2F is an example of pseudocode for an algorithm that may be used to implement a portion of the computing system of FIG. 1.

FIG. 3A is a flow diagram of a process that may be executed by at least one device of the computing system of FIG. 1.

FIG. 3B is a flow diagram of a process that may be executed by at least one device of the computing system of FIG. 1.

FIG. 4A is a flow diagram of a process that may be executed by at least one device of the computing system of FIG. 1

FIG. 4B is a flow diagram of a process that may be executed by at least one device of the computing system of FIG. 1.

FIG. 5A, FIG. 5B, and FIG. 5C are captures of examples of user interface elements that may be used to implement a portion of the computing system of FIG. 1.

FIG. 6 is a block diagram illustrating an embodiment of a hardware system, which may be used to implement various aspects of the computing system of FIG. 1.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Overview

Search engines continue to be challenged by natural language queries. This technical problem is especially acute for general-purpose search engines, which may return a plethora of search results from many different categories of information, thereby producing a content-rich but complex and potentially overcrowded search results page. For example, in a connections network-based system, a search query may return news articles, user profiles, company profiles, and job postings that all match the query terms, and display those results all on the same results page. Such multi-dimensional results pages may detract from the user experience with the search engine, particularly when complex pages are displayed on a small form factor display device such as a smart phone, wearable device, or tablet computer.

Examples of connections network-based systems include but are not limited to online networks, such as social networks, and application software that interacts with online networks. Examples of application software that may interact with online networks include but are not limited to recruiting, online learning, and job search applications.

As used here, “online” may refer to a particular characteristic of a connections network-based system. For example, many connections network-based systems are accessible to users via a connection to a public network, such as the Internet. However, certain operations may be performed while an “online” system is in an offline state. As such, reference to a system as an “online” system does not imply that such a system is always online or that the system needs to be online in order for the disclosed technologies to be operable.

To improve a search engine's ability to deliver highly relevant search results in as few user interface-driven iterations as possible, many different technical approaches have been explored. Attempts have been made to apply supervised machine learning techniques to evaluate user feedback on search results produced by search engines in response to user-supplied search queries. Supervised machine learning approaches have been sub-optimal due to their inability to adequately handle noisy labels. For example, supervised machine learning requires individual training instances of user feedback to be discretely labeled as positive or negative. However, user feedback is not always positive or always negative with a high degree of certainty. Temporary inaction by the user may not be a signal of negative feedback, for instance.

Another drawback of supervised machine learning techniques is that while they can be used to interpret discrete actions, they are not as effective to interpret user activities in the context of longer sequences of events. Additionally, since filters traditionally have been static, attempts to improve the search experience have resulted in a proliferation of static filters on a search interface. A large number of filters has proven overwhelming and confusing for the user.

There are different ways of defining filters in order to help users narrow their searches. Hard-coding filters based on domain knowledge is one approach. Other approaches may define filters using a faceted classification system, in which case the term “facet” may be used to refer to a type of filter. Examples of commonly used general-purpose facets are time, place, and form. For purposes of this disclosure, the terms “facet” and “filter” may be used interchangeably. However, the technologies described herein are applicable to many different approaches for defining search filters and are not limited to facet-based approaches.

In addition to the above-mentioned challenges, the disclosed technologies are directed to reducing user friction caused by presentations of out-of-order, incorrect, or less relevant search results. For instance, in online coaching, learning, and education applications, it can be important for content to be retrieved and presented in a logical order. As an example, it may be important for a Cooking Basics video to be ordered before an Advanced Cooking video in search results presented for particular users. Navigation-based improvements provided by the disclosed technologies can incorporate these and other types of constraints and thereby increase user engagement with the software product.

Embodiments of the disclosed technologies have configured an advanced machine learning agent, which includes one or more reinforcement learning-based software agents. The incorporation of reinforcement learning enables navigational elements of the search interface to be dynamically configured based on sequences of user activities occurring during a search session. Embodiments apply reinforcement learning to continuously adapt navigational elements presented by a search interface in response to user feedback over the course of a session. Using reinforcement learning, a navigation agent determines which navigation element or elements to present to a user at particular times during the user's search session in order to increase the likelihood of a positive user experience with the search interface.

In an embodiment, the navigation agent computes reward scores that quantify the effectiveness of different particular computer-generated navigation element options. Reward scores are based on user state data that has been collected during a search session with a particular user as well as user state data that has been collected from a population of other users of the search interface. The navigation agent selects navigation elements to present to the user based on the reward scores. The navigation agent adaptively determines the effectiveness of a selected navigation element by continuing to process user state data after a selection has been made by the navigation agent.

For ease of discussion, as used herein, the term “option” may refer to one of a group of computer-generated navigation elements that may be selected by the navigation agent using, for example, one or more of the disclosed reinforcement learning-based processes. For example, embodiments of the navigation agent may generate several navigation element options from which the navigation agent may select one or more of those options to present to the user at a particular time during the user's search session. A particular navigation element option selected by the navigation agent may be referred to as a computer-selected navigation element.

Presentation to the user of a computer-selected navigation element by the search interface may be referred to as an “action.” As such, an “action” as used herein may refer to an operation or process that is performed by the search interface, the navigation agent, or one or more other components of system 100. After the search interface has presented a particular computer-selected navigation element to the user, if the user then selects that particular computer-selected navigation element, for example, to include in the user's search query, the navigation agent may ingest the user state data corresponding to the selection of the particular computer-selected navigation element as user feedback.

User selections of navigation elements and other user interactions with system 100 may be referred to as “activities.” When the search interface presents multiple computer-selected navigation elements to the user, those navigation elements may be referred to herein as “choices.” Thus, as used herein, “action” may refer to an operation or process performed by one or more processors while “activity” may refer to a user-initiated interaction between the user and system 100. Also, “option” may refer to a computer-generated navigation element that may be selected by the navigation agent via a reinforcement learning-based process while “choice” may refer to a computer-generated navigation element option that may be presented to, and may be selected by, the user via a user interface.

Terms such as “computer-generated” and “computer-selected” as used herein may refer to a result of an execution of one or more computer program instructions by one or more processors of, for example, a server computer, a network of server computers, a client computer, or a combination of a client computer and a server computer.

Examples of computer-generated navigation elements that the disclosed technologies may generate and provide to the search interface at any time during a session include but are not limited to computer-generated search re-formulations, such as re-formulations of the user's original query that may refine or expand the user's previous query, computer-generated dynamic re-configurations of search filters and/or facet types, computer-generated conversational query disambiguation elements such as clarifying prompts and informational content elements such as coaching videos and help messages designed to help a new user navigate a search page, presentations of search results retrieved by the search engine, or any combination of any of the foregoing or other forms of navigation elements. The presentation of search results is, for purposes of this disclosure, considered a computer-generated navigation element because the presentation of search results is an option that may be selected by the navigation agent. For example, the navigation agent may determine to both display search results and display search re-formulations and/or re-configured filters.

Experiments have shown that the disclosed technologies are capable of, for example, improving the quality of computer-generated re-formulated searches and reducing the number of computer-generated re-formulated searches to a smaller number of more pertinent options. Table 1 below shows a comparison of search re-formulation options generated using the disclosed technologies versus those obtained using a supervised machine learning model.

TABLE 1
Example of experimental results.

| “logistics specialist” | | “specialist” | | “logistics” | |
|---|---|---|---|---|---|
| | Supervised | | Supervised | | Supervised |
| RL | ML | RL | ML | RL | ML |
| Project | Director | Technology | Venture | Supply chain | Head chain |
| implementation | technology | specialist | specialist | | management |
| specialist | | | | | |
| Technology | Clinical | | Junior | Supply chain | Social chain |
| implementation | experience | | specialist | management | manager |
| specialist | management | | | | |
| | Manager | | Billing | | Logistics |
| | implementation | | specialist | | chain |
| | specialist | | | | management |

The first row of Table 1 shows three examples of original search queries. The remainder of the table shows examples of computer-generated search re-formulation options that were produced using the disclosed technologies (“RL” columns) and using a supervised machine learning model (“Supervised ML” columns). As can be seen from Table 1, there is much greater variation in the options produced by the supervised machine learning system. These differences may be attributed to the fact that the supervised machine learning system is incapable of using the larger context of the search session to generate options.

Examples of benefits of the disclosed technologies include reductions in the volume of information shown to the user in response to the user's query, improvements in the relevance, accuracy and arrangement of both navigation elements and search results presented to the user, and increased use of search-driven aspects of software products.

### Example Computing System

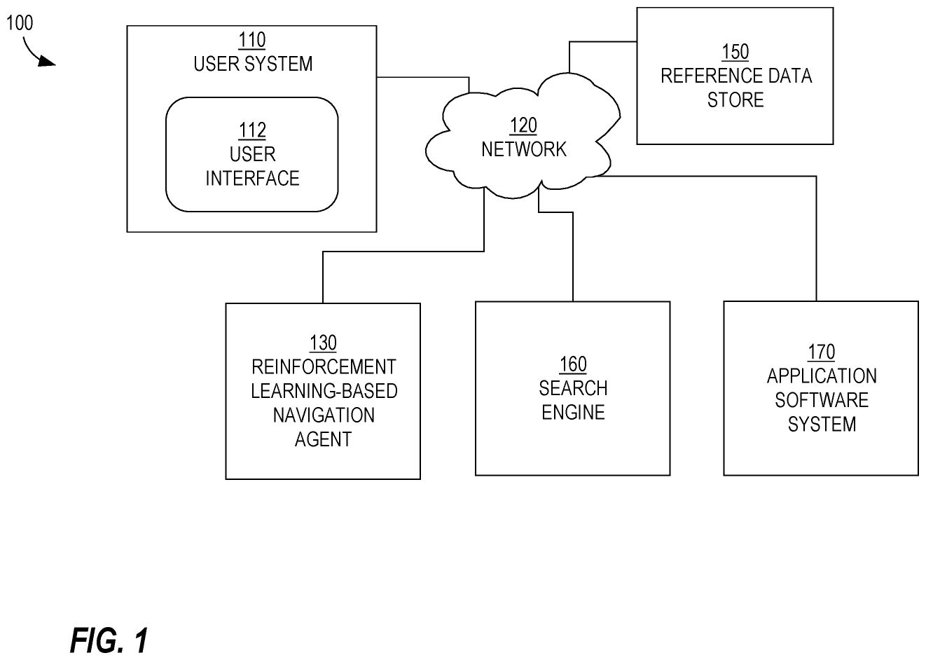

FIG. 1 illustrates a computing system in which embodiments of the features described in this document can be implemented. In the embodiment of FIG. 1, computing system 100 includes a user system 110, a reinforcement learning-based navigation agent 130, a reference data store 150, a search engine 160, and an application software system 170.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 may be or include front-end portions of reinforcement learning-based navigation agent 130, search engine 160, and/or application software system 170.

User interface 112 is any type of user interface as described above. User interface 112 may be used to view or otherwise perceive navigation elements produced by reinforcement learning-based navigation agent 130. For example, user interface 112 may include a graphical user interface alone or in combination with an asynchronous messaging interface, which may be text-based or include a conversational voice/speech interface. User interface 112 may make search queries available for processing by reinforcement learning-based navigation agent 130 via a front-end component of search engine 160 and/or application software system 170.

A search query can be created and stored in computer memory as a result of a user operating a front end portion of search engine 160 or application software system 170 via user interface 112. Search engine 160 is configured to process and execute search queries on stored content and return search results in response to the search queries. Search engine 160 is capable of processing and executing search queries that include natural language text alone or in combination with structured query terms such as filters and/or pre-defined sort criteria. Search engine 160 may be a general purpose search engine or a specific purpose search engine, and may be part of or accessed by or through another system, such as application software system 170.

Application software system 170 is any type of application software system. Examples of application software system 170 include but are not limited to connections network software and systems that may or may not be based on connections network software, such as job search software, recruiter search software, sales assistance software, advertising software, learning and education software, or any combination of any of the foregoing.

While not specifically shown, it should be understood that any of reinforcement learning-based navigation agent 130, search engine 160 and application software system 170 includes an interface embodied as computer programming code stored in computer memory that when executed causes a computing device to enable bidirectional communication between application software system 170 and/or search engine 160 and reinforcement learning-based navigation agent 130. For example, a front end of application software system 170 or search engine 160 may include an interactive element that when selected causes the interface to make a data communication connection between application software system 170 or search engine 160, as the case may be, and reinforcement learning-based navigation agent 130. For example, a detection of user input, or a detection of a user selection of a computer-generated re-formulated search candidate, in a front end of application software system 170 or search engine 160, may initiate data communication with reinforcement learning-based navigation agent 130 using, for example, an application program interface (API).

Reinforcement learning-based navigation agent 130 computes reward scores based on user state data collected and stored over the course of a user's current search session and, in some embodiments, historical user state data collected over one or more previous search sessions. Reinforcement learning-based navigation agent 130 uses the reward scores to dynamically select or re-configure navigation elements to be presented to the user during the current search session. Output produced by reinforcement learning-based navigation agent 130 may be provided to search engine 160, application software system 170 and/or displayed by user interface 112, for example.

Reinforcement learning-based navigation agent 130 may include one or more navigation sub-agents. In an embodiment, Reinforcement learning-based navigation agent 130 includes at least two navigation sub-agents, each of which provide output to a top-level reinforcement learning-based navigation agent. In some embodiments, one or more of the navigation sub-agents are themselves implemented using reinforcement learning. Example embodiments of reinforcement learning-based agent 130 are described in more detail below.

Examples of user state data include user responses to presentations of content (e.g., clicks or taps on content items), user activities such as entering a search query, selecting a navigation element, entering input in response to a navigation element, initiating a connect request, sharing content, sending of messages, and user inactivity defined by time intervals during which there is an absence of user activity. User activities may include cross-application actions. For example, in a connections network-based system, user activities can include user interactions with a connection network portion of the software, interactions with a job search portion of the software, and interactions with a learning portion of the software, over a time interval. User state data also includes session identifier data and timestamp data associated with corresponding user activities associated with different sessions. Thus, user state data can include data collected across different sessions of the same user or across multiple different users. User activities can be explicit or implicit. Examples of explicit user activities include clicking on search results, connection requests, clicking a “thumbs up” or “like” button, and submitting a job application. Examples of implicit user activities include navigating away from a search result, failing to select a computer-generated re-formulated search, and failing to select a computer-generated filter element.

Examples of navigation elements include user interface elements such as computer-generated re-formulated searches, computer-generated search filters, conversational dialog-based elements such as clarifying questions and query expansion or refinement options, system-selected training elements such as online videos, and computer-generated search results, such as search results generated in response to a previous search query. User interface elements may be presented to the user by way of a graphical user interface and/or computer-generated speech, for example.

Reference data store 150 includes at least one digital data store that stores data sets used to train, test, use, and tune reinforcement learning models that form portions of reinforcement learning-based navigation agent 130 or are otherwise used to operate reinforcement learning-based navigation agent 130. Examples of data that may be stored in reference data store 150 include but are not limited to search query data, user state data, user metadata, navigation elements, model training data such as population state data, reward scores, semantic embeddings, similarity scores, model parameter and hyperparameter values, and weight values. Stored data of reference data store 150 may reside on at least one persistent and/or volatile storage device that may reside within the same local network as at least one other device of computing system 100 and/or in a network that is remote relative to at least one other device of computing system 100. Thus, although depicted as being included in computing system 100, portions of reference data store 150 may be part of computing system 100 or accessed by computing system 100 over a network, such as network 120.

A client portion of reinforcement learning-based navigation agent 130, search engine 160 or application software system 170 may operate in user system 110, for example as a plugin or widget in a graphical user interface of a software application or as a web browser executing user interface 112. In an embodiment, a web browser may transmit an HTTP request over a network (e.g., the Internet) in response to user input (e.g., entering of a text sequence) that is received through a user interface provided by the web application and displayed through the web browser. A server portion of reinforcement learning-based navigation agent 130 and/or search engine 160 may receive the input, perform at least one operation to analyze the input, and return at least one modified version of the input using an HTTP response that the web browser receives and processes.

Each of user system 110, reinforcement learning-based navigation agent 130, search engine 160 and application software system 170 is implemented using at least one computing device that is communicatively coupled to electronic communications network 120. Reinforcement learning-based navigation agent 130 is bidirectionally communicatively coupled to user system 110, reinforcement learning-based navigation agent 130, search engine 160 and application software system 170, by network 120. A different user system (not shown) may be bidirectionally communicatively coupled to application software system 170. A typical user of user system 110 may be a customer service representative or an administrator or a product manager for application software system 170 or an end user of application software system 170. User system 110 is configured to communicate bidirectionally with at least reinforcement learning-based navigation agent 130, for example over network 120. Examples of communicative coupling mechanisms include network interfaces, inter-process communication (IPC) interfaces and application program interfaces (APIs).

The features and functionality of user system 110, reinforcement learning-based navigation agent 130, reference data store 150, search engine 160, and application software system 170 are implemented using computer software, hardware, or software and hardware, and may include combinations of automated functionality, data structures, and digital data, which are represented schematically in the figures. User system 110, reinforcement learning-based navigation agent 130, reference data store 150, search engine 160, and application software system 170 are shown as separate elements in FIG. 1 for ease of discussion but the illustration is not meant to imply that separation of these elements is required. The illustrated systems and data stores (or their functionality) may be divided over any number of physical systems, including a single physical computer system, and can communicate with each other in any appropriate manner.

Network 120 may be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

It should be understood that computing system 100 is just one example of an implementation of the technologies disclosed herein. While the description may refer to FIG. 1 or to “system 100” for ease of discussion, other suitable configurations of hardware and software components may be used to implement the disclosed technologies. Likewise, the particular embodiments shown in the subsequent drawings and described below are provided only as examples, and this disclosure is not limited to these exemplary embodiments.

### Example System Architecture

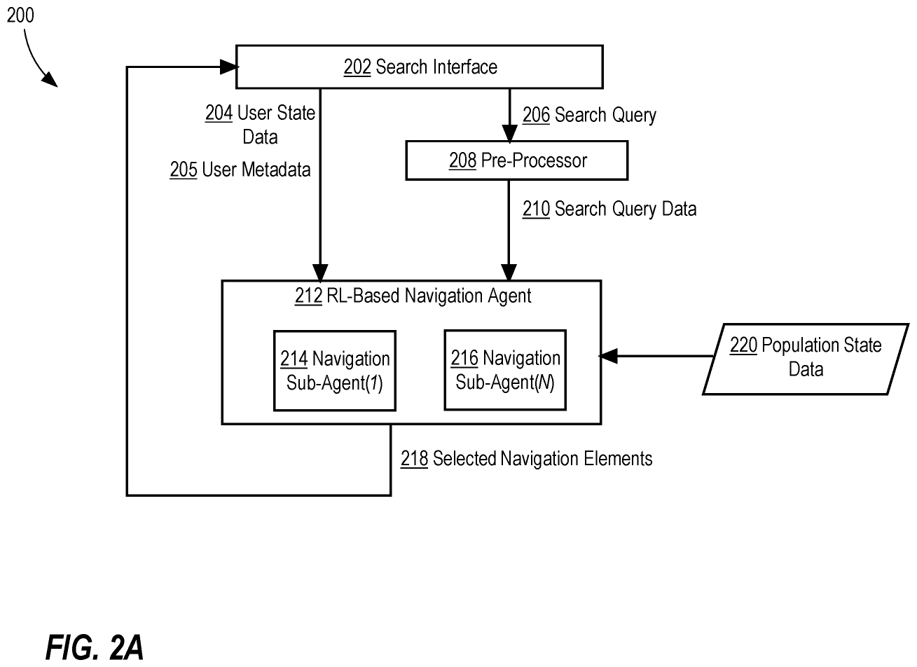

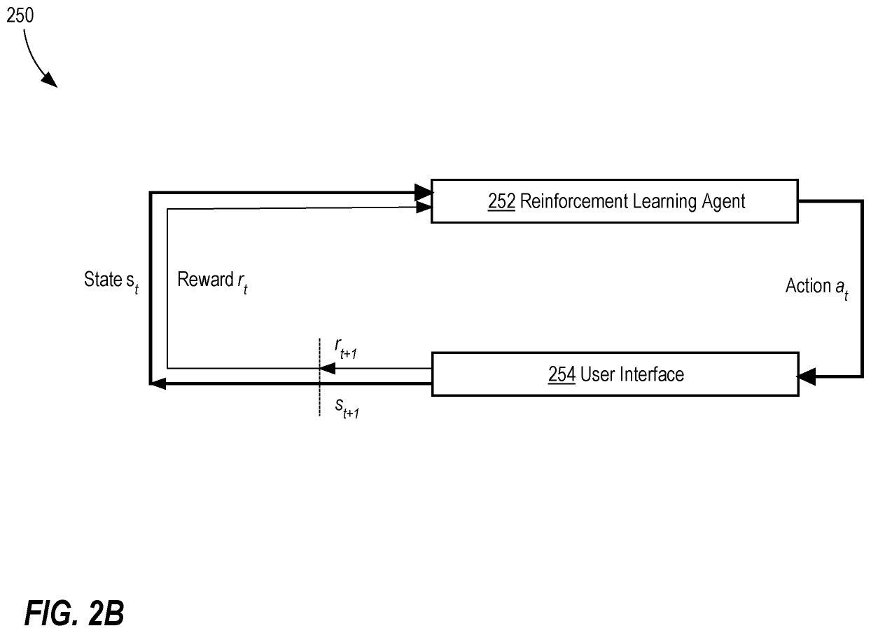

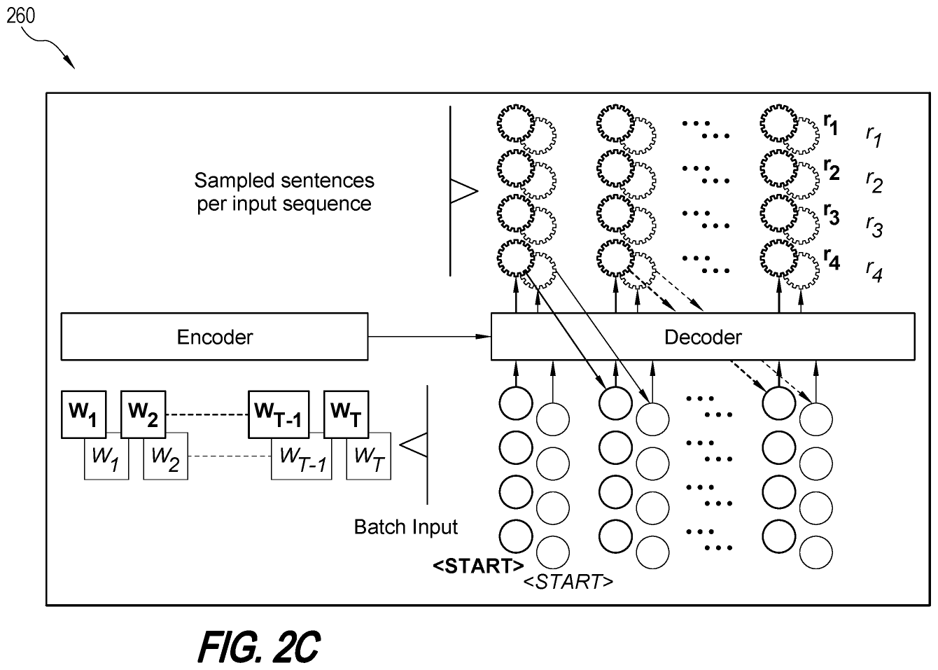

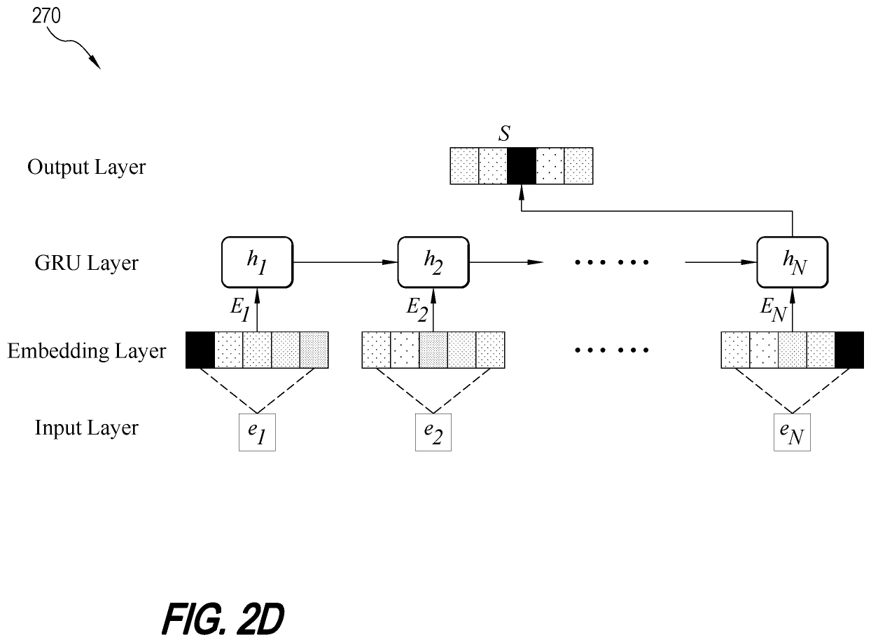

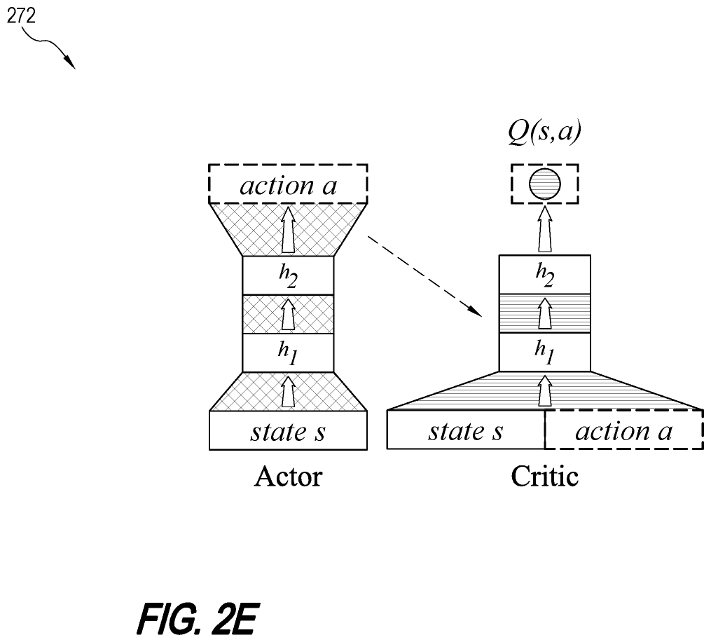

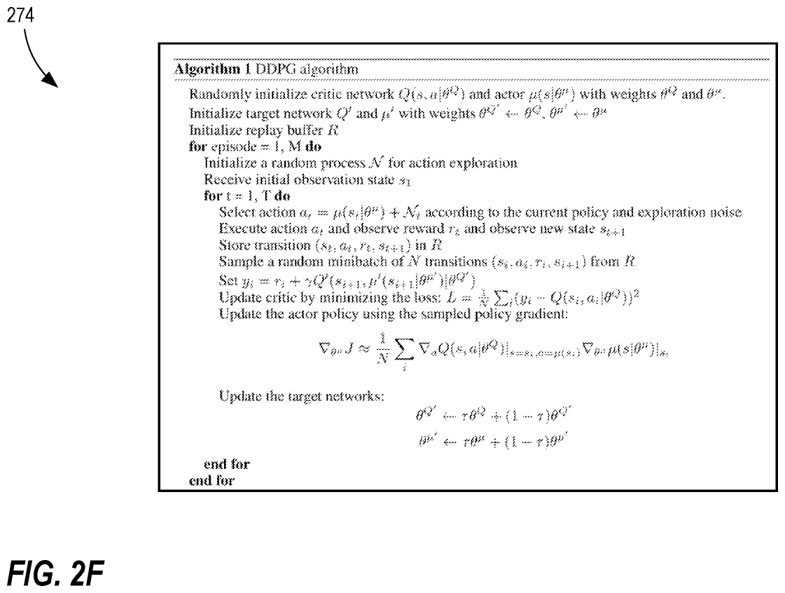

FIG. 2A is a schematic diagram of an arrangement of software-based components of an embodiment of a system architecture 200 for computing system 100, which may be stored on at least one device of the computing system of FIG. 1, and shows examples of flows between components including inputs and outputs.

In FIG. 2A, a search interface 202 receives computer-based interactions of an end user with, for example, a front end of search engine 160 or application software system 170, and outputs navigation elements during a search session. Search interface 202 may be implemented as a component of user interface 112. An example of a search session is a temporal sequence of user activities and system actions that begins with an input of a search query and ends with, for example, a closing of a front end portion of search engine 160 or application software system 170, a clearing of a search input box, or a clearing of all search filters. Closing a web browser or a mobile device application may operate to end a search session, for example.

A search session can span multiple different device platforms. For example, a user may begin a search session by entering a query on a mobile device and continue the search session on a laptop computer, or the user may begin a search session by entering a query on a laptop computer and continue the search session on a mobile device. Moreover, a search session can span user activities across multiple portions of application software system 170. For example, a search session may begin with a job search but also include user activities such as issuing connection requests to other users whose profiles have been retrieved during the search session and viewing of learning videos retrieved during the search session.

Through computer-based interactions with an end user, search interface 202 extracts user state data 204, user metadata 205, and search query 206 from the search session. Examples of user state data 204 include the examples of user state data provided above. Example of user metadata 205 include user account identifier data, user account creation timestamp data, user profile data, session identifier data, session timestamp data, and user activity timestamp data. An example of user activity timestamp data is a discrete data value that indicates the date and time at which a user activity has been detected by search interface 202 or by system 100 more generally. In general, timestamp data as used herein may refer to discrete date and time values obtained from a system clock.

User account creation data timestamp data is used, in some embodiments, as an indicator of the user's level of sophistication with particular software. For example, if the difference between a user account creation timestamp and the timestamp of the current search session is small (e.g., less than or equal to 30 days), system 100 may consider the user “new” which may bias system 100 to invoke reinforcement learning-based navigation agent 130 more frequently than if the user is considered “seasoned” (e.g., the difference between a user account creation timestamp and the timestamp of the current search session is large, such as greater than 30 days). Alternatively or in addition, account data timestamp data is used by RL-based navigation agent 212 and/or one or more navigation sub-agents 214, 216 as a factor in computing reward scores, generating navigation element options, or selecting navigation elements.

Search query 206 is a text string. Search query 206 includes natural language text and may also include structured query terms such as filters or sort criteria. As used herein, “natural language” may refer to unstructured text that is input into a free-form text box via, for example, a keypad or a microphone. In some embodiments, search query 206 may further include computer-generated re-formulated search choices and/or computer-generated filter choices that have been previously produced by RL-based navigation agent 212 using the disclosed technologies and presented to the user by search interface 202. In some embodiments, search query 206 also includes indications of whether any of those computer-generated navigation choices have been selected by the user.

Natural language text of search query 206 may have been entered by the user into a text box of search interface 202. Alternatively, the natural language text of search query 206 may be a computer-generated search choice selected by the user via a navigation element of search interface 202. In some embodiments, search query 206 may include a text string corresponding to natural language speech spoken by the user, in which case the text string may have been produced by, for example, automatic speech recognition (ASR) software. Thus, a search query 206 may include a combination of both unstructured text and structured text.

Search query 206 is pre-processed by pre-processor 208. Examples of pre-processing that may be performed on search query 206 include but are not limited to syntactic parsing and semantic parsing. After pre-processing, pre-processor 208 outputs search query data 210. An example of search query data 210 is a structured representation of search query 206. For instance, search query data 210 may include syntactic and/or semantic tags along with the raw text of search query 206.

As another example of a structured representation of search query 206, search query data 210 may be formulated as a semantic interpretation of search query 206, which may take the form of an intent. An example of an intent is a semantic label that represents the meaning of the query; for example, Find_Job or Find_Contact. The intent may have parameters or “slots,” which are variable names corresponding to variable data values, where an instance of a variable data value may be supplied by search query 206. For example, in the intent Find_Job(Title, Skills), both “Title” and “Skills” are search parameters. If search query 206 contains a value or values that correspond to any of these parameters, pre-processor 208 inserts them into the corresponding parameter slots of the intent. For example, in the intent, Find_Job(“software engineer,” null), the user has supplied the search term “software engineer,” which corresponds to the “Title” parameter, but has not supplied a value for Skills. Pre-processor 208 may determine that search query 206 is ambiguous if, for example, search query 206 does not contain enough information to fill one or more of the slots of the intent.

User state data 204, user metadata 205 and search query data 210 are provided to or received by RL-based navigation agent 212. In the embodiment of FIG. 2A, RL-based navigation agent 212 is a software component or a collection of software components that includes multiple machine learning-based sub-components. RL-based navigation agent 212 includes N navigation sub-agents 214, 216 (where Nis a positive integer) as well as a navigation agent 212.

In an embodiment, RL-based navigation agents 212, 214, 216 are arranged in a hierarchical manner in which navigation agent 212 processes output of RL-based navigation sub-agents 214, 216 and selects navigation options from among the options that have been output by the sub-agents 214, 216, whereas navigation sub-agents 214, 216 produce outputs for processing by navigation agent 212 but do not process outputs of other navigation agents. For example, if sub-agent 214 outputs one or more query re-formulation options and sub-agent 216 outputs one or more filter options, navigation agent 212 may select as navigation options a query re-formulation option and/or a filter option, only query reformulation options, only filter options, or any combination of the navigation options produced by sub-agents 214, 216. In other embodiments, navigation agent 212 and navigation sub-agents 214, 216 are arranged in a non-hierarchical manner in which one or more of the agents 212, 214, 216 operate independently of the other agents. For example, navigation agent 212 may generate and select a conversational disambiguation option while sub-agent 214 independently generates and selects a query-reformulation option and sub-agent 216 independently generates and selects a filter option.

The number of RL-based agents and/or sub-agents is determined by the number of different types of navigation element options which themselves may generate multiple different options, in an embodiment. For example, at a given user state, the user may be presented with any number of query re-formulations and/or any number of filter elements. Thus, an RL-based agent can be used to facilitate the selection of query re-formulations, if any, to be presented to the user. Likewise, another RL agent can be used to facilitate the selection of filter elements, if any, to be presented to the user. If there are other types of navigation options available, additional RL agents may be provided.

In an embodiment, RL-based navigation agent 212 and at least one of navigation sub-agents 214, 216 are implemented using advanced machine learning, such as reinforcement learning. In the embodiment of FIG. 2A, navigation agents 212, 214, 216 are each reinforcement learning-based agents trained using population state data 220. Examples of population state data 220 are user state data collected for a population of users of search engine 160 and/or application software system 170. Examples of model configurations that may be used to implement one or more of navigation sub-agents 212, 214, 216 are shown in FIG. 2C, FIG. 2D, FIG. 2E, and FIG. 2F, described below.

Population state data 220 includes sequences of user states of users in a population of users. Such user states include user states detected after presentations of computer-generated navigation element choices to users of the population of users, where the computer-generated navigation element choices have been presented in response to natural language search queries, and the natural language search queries have been received from the users in the population of users during sessions of the population of users. Embodiments of reinforcement learning-based navigation agents are described in greater detail in the sections that follow.

Each navigation sub-agent 214, 216 receives user state data 204, search query data 210 and optionally, user metadata 205. Using user state data 204, search query data 210, and optionally, user metadata 205, each navigation sub-agent 214, 216 generates a different type of optional navigation element and computes reward scores for the navigation elements it generates. For example, navigation sub-agent 212 may generate search options and corresponding reward scores, and navigation sub-agent 214 may generate filter options or conversational disambiguation element options, and corresponding reward scores.

The overall RL-based navigation agent 212 evaluates reward scores produced by each of navigation sub-agents 214, 216 for various computer-generated navigation element options, and selects navigation elements from those options for output based on the reward scores. For instance, RL-based navigation agent 212 may select one or more search re-formulation options, one or more query re-formulations, one or more filter elements, one or more conversational disambiguation elements, one or more search result elements, or a combination of any of the foregoing options, for output, based on the reward scores. RL-based navigation agent 212 provides the one or more selected navigation elements 218 for output by search interface 202.

### Example Reinforcement Learning Process

FIG. 2B is a schematic diagram of an arrangement of software-based components of an embodiment of a reinforcement learning process 250 of computing system 100, which may be stored on at least one device of the computing system of FIG. 1.

In FIG. 2B, at a timestamp t which signifies the beginning of a search session, the user state is sₜ and sₜ has a corresponding reward score rₜ. A reinforcement learning agent 252 selects an action aₜ, from a set of action options, based on the user state sₜ and corresponding reward score rₜ. Reinforcement learning agent 252 provides the action aₜ for output by user interface 254. Reinforcement learning agent 252 is, for example, navigation agent 212, navigation sub-agent 214, navigation sub-agent 216, or a combination of any two or more of navigation agent 212, navigation sub-agent 214, and navigation sub-agent 216. Examples of actions at include but are not limited to instructions for presentation of one or more computer generated navigation elements such as search re-formulation options, query re-formulations, filter elements, conversational disambiguation elements, search results, or a combination of any of the foregoing.

User interface 254 is, for example, search interface 202, described above. In response to aₜ, a state transition to a new user state sₜ₊₁ is detected and a corresponding reward score rₜ₊₁ is computed based on (sₜ, aₜ, rₜ) and sₜ₊₁, e.g., a cumulative sequence of actions, reward scores, and user states since the beginning of the search session. The algorithms used to compute reward scores are configurable and may vary depending on the type of action. For example, reward scores may be computed differently for different types of navigation elements. In general, reinforcement learning agent 252 receives feedback from the user's computing environment about sequential actions and seeks to maximize cumulative reward over an entire search session as opposed to maximizing utility of a single action in isolation.

### Example Model Architecture for Query Re-Formulation

FIG. 2C is a schematic diagram of a reinforcement learning-based software agent that may be used to implement a portion of the computing system of FIG. 1. In particular, FIG. 2C illustrates an encoder-decoder neural machine translation (NMT) model 260 that has been adapted and pre-trained to generate query re-formulation options that can be scored and selected by an RL agent, such as RL agent 212, 214, or 216 based on user state data.

For example, query re-formulation options output by model 260 may be presented to the particular user and/or a population of users over a series of search sessions during which user feedback is collected, and the resulting user feedback is scored by an RL agent using the methods for computing reward scores described herein, and the reward scores are used to train the RL agent or to adapt the RL agent to user preferences as they change over time.

To produce query re-formulation options, neural machine translation model 260 uses an artificial neural network to predict the likelihood of a sequence of words. The model 260 takes as input a user's search query, as an entire sequence rather than individual words, and outputs one or more new versions of the user's query, where each new version of the user's query is a simulated sequence. The input query and the computer-generated sequences can be of arbitrary length.

Whereas existing maximum-likelihood estimation (MLE)-based Seq2Seq models can only feed non-curated “co-occurring” queries into training, without considering any downstream user actions as an optimization objective, model 260 can be trained using reward scores computed by the RL agent. In this way, the downstream user actions occurring in response to a presentation to the user of a computer-selected query re-formulation option can be incorporated into the model training data.

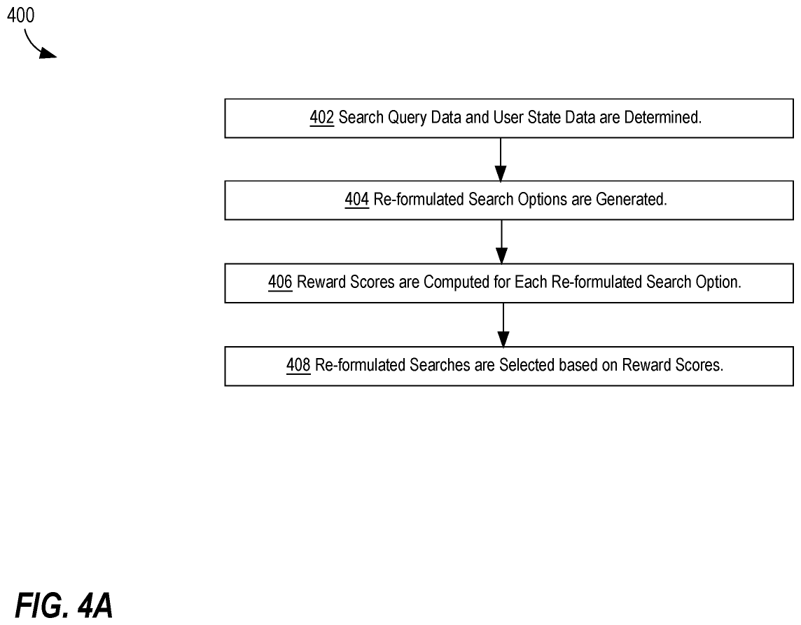

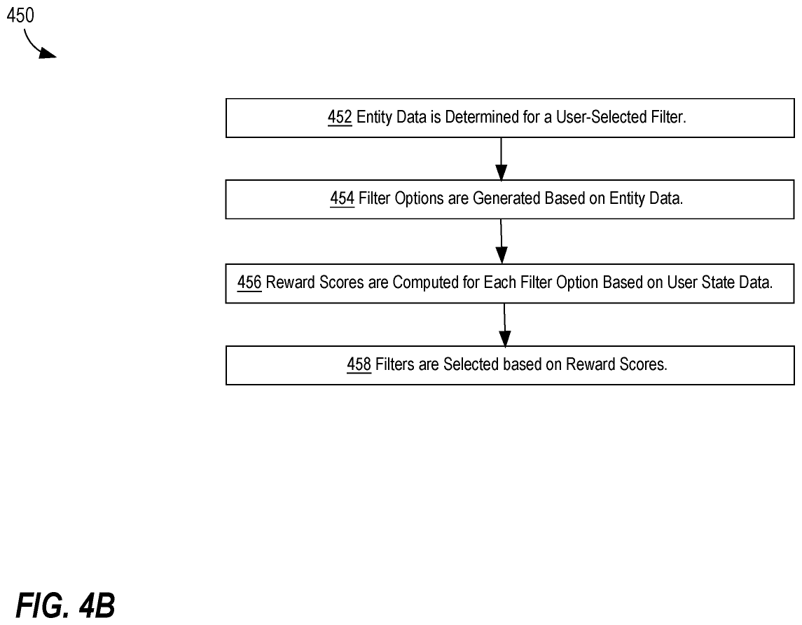

As described below with reference to FIG. 4A, reward scores computed by the RL agent measure certain properties of the computer-generated query re-formulation options, such as semantic coherence, diversity, or capturing the dynamics of generating the sequence of words. The RL agent uses these reward scores to improve the selection of query re-formulation options. For example, the RL agent may select a query re-formulation option that has a high semantic coherence and positive user feedback scores over another query reformulation option that has a low semantic coherence and positive user feedback scores, or the RL agent may select a query re-formulation option that has a low semantic coherence and a positive user feedback score over another query re-formulation option that has a high semantic coherence score and a neutral user feedback score.

### Example Architecture for Filter Elements

FIG. 2D and FIG. 2E are schematic diagrams of portions of a reinforcement learning-based software agent that may be used to implement a portion of the computing system of FIG. 1. FIG. 2F is an example of pseudocode for an algorithm that may be used to implement a portion of the computing system of FIG. 1.

An embodiment of the RL agent for generating and selecting filter elements is modeled as a Markov Decision Process (MDP) as shown in FIG. 2B, described above. The RL agent interacts with users to suggestion a list of filter element options sequentially over a set of timestamps during the user's session by maximizing the cumulative rewards of the entire session.

FIG. 2D illustrates an example of a neural network architecture 270 for generation of a state S. In an embodiment, the MDP defines a new user state, sₜ₊₁, as follows: sₜ₊₁=ƒ(sₜ, eₜ), where the function ƒ is defined as a recurrent neural network (RNN) as shown in FIG. 2D, sₜ is a current user state, and et is a current filter element. In FIG. 2D, the Embedding Layer generates semantic embeddings E₁, E₂, . . . E_{N} for each corresponding filter element option e₁, e₂, . . . e_{N}. GRU (Gated Recurring Units) is used for the hidden layer h₁, h₂ . . . h_{N} rather than Long Short-Term Memory (LSTM) because GRU outperforms LSTM for capturing users' sequential preference in some recommendation tasks.

FIG. 2E illustrates an actor-critic framework 272 in which an action a is defined as a continuous weight vector and Q(s, a), is a state-action value function. In the illustrated embodiment, the actor-critic framework is used to solve the MDP problem. In one particular embodiment, the actor-critic framework is implemented using a model-free off-policy actor-critic Deep Deterministic Policy Gradient (DDPG) algorithm. FIG. 2F illustrates an example of a DDPG algorithm 274 that may be used in the actor-critic framework of FIG. 2E. The maximization objective of the RL problem can be solved using a value-based method or a policy gradient method. The state-action value function can be estimated by function approximation with mean squared error minimization

### Example Navigation Process

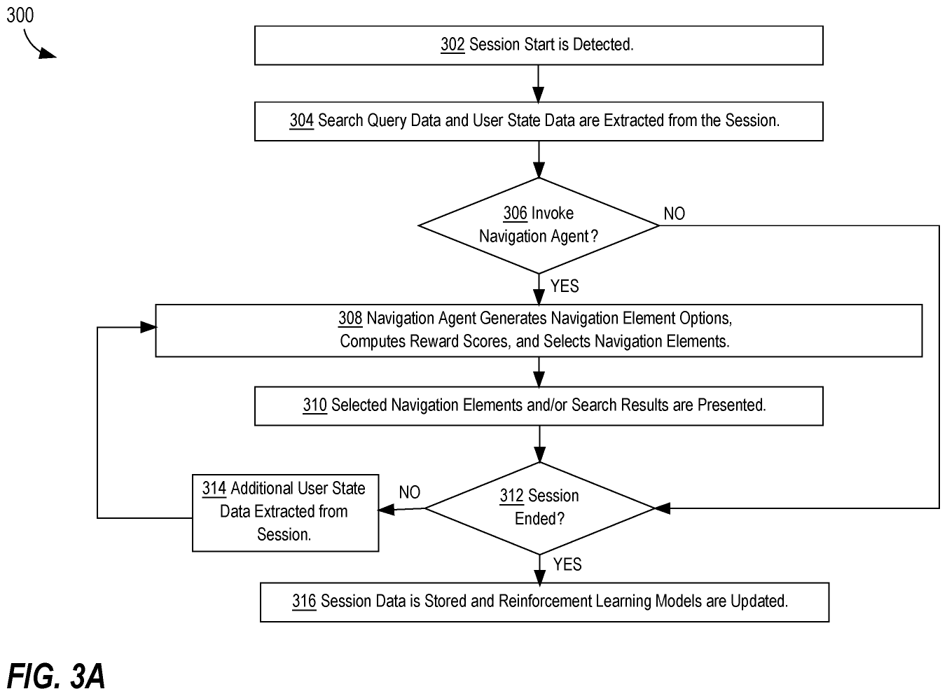

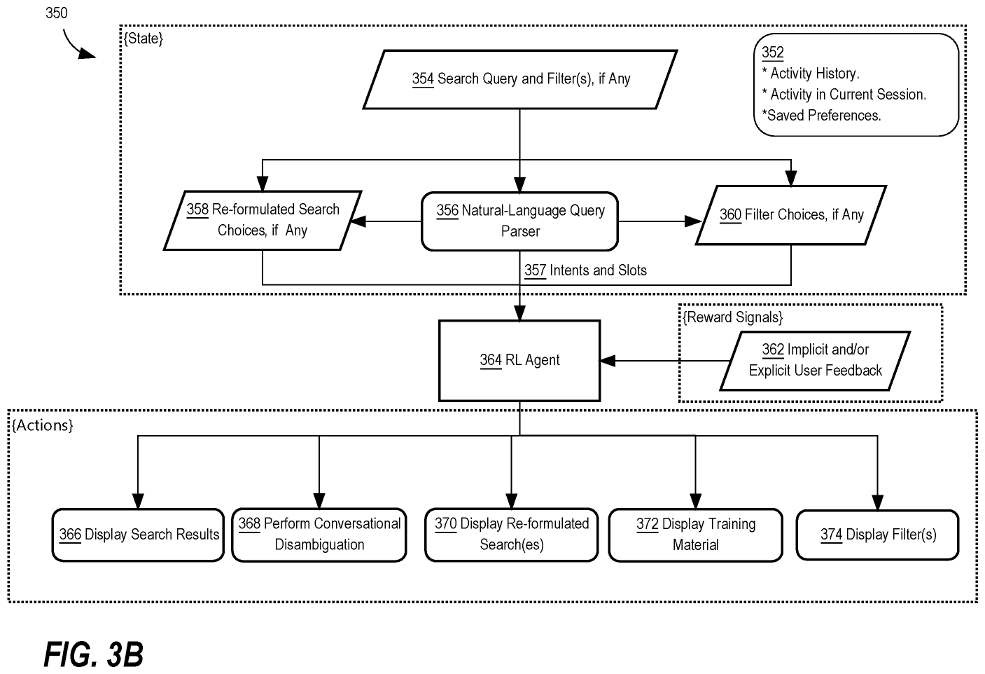

FIG. 3A is a simplified flow diagram of an embodiment of operations that can be performed by at least one device of a computing system. The operations of a flow 300 as shown in FIG. 3A can be implemented using processor-executable instructions that are stored in computer memory. For purposes of providing a clear example, the operations of FIG. 3A are described as performed by computing system 100, but other embodiments may use other systems, devices, or implemented techniques.

Operation 302 when executed by at least one processor causes one or more computing devices to detect the start of a search session. Operation 302 can be performed by, for example, detecting input of a natural language search query into a text inbox of a user interface or detecting selection of a computer-generated navigational element presented by a user interface, such as a computer-generated re-formulated search or a computer-generated filter element.

Operation 304 when executed by at least one processor causes one or more computing devices to extract search query data and user state data from the search session detected by operation 302. Search query data may include, for example, search query data 210, described above. User state data may include, for example, user state data 204, described above. Optionally, in operation 304, user metadata, such as user metadata 205, described above, also may be extracted from the search session. Data extraction may be performed, for example, using SPARK/SCALA scripts.

Operation 306 when executed by at least one processor causes one or more computing devices to invoke the navigation agent or not invoke the navigation agent. To determine whether to invoke the navigation agent, operation 306 may process search query data, user state data, user metadata, or a combination of any of the foregoing. For example, if a comparison of user account creation timestamp data to session timestamp data exceeds a threshold duration of time and thereby indicates that the user who entered the search query is a “power user,” operation 306 may not invoke the navigation agent or may invoke only a portion of the navigation agent. On the other hand, if the comparison of user account create timestamp data to session timestamp data is less than the threshold duration of time and thereby indicates that the user who entered the search query is a new user, or a comparison of session timestamp data to a current value of the system clock indicates that the search session has just started, operation 306 may invoke the navigation agent.

As another example, if a search query is determined to be unambiguous, for instance by a semantic parser having determined that an intent is “complete” because all of the intent's slots have been filled with data values from the user's input, then operation 306 may not invoke the navigation agent. On the other hand, if a semantic parser determines that an intent is ambiguous because one or more of an intent's slots have not been filled in with data values from the user's input, or the semantic parser has a low confidence in the assignment of user-input data values to slots of the intent, or the semantic parser has a low confidence in the intent determination itself (for example, the semantic parser has a 50% confidence that the intent is “Find_Job” and 50% confidence that the intent is “Find_Company”), then operation 306 may invoke the navigation agent.

If operation 306 invokes the navigation agent, operation 308 when executed by at least one processor causes one or more computing devices to generate navigation element options, compute reward scores, and select navigation elements for output by the user interface. Examples of processes that may be performed by operation 306 are described with reference to FIG. 4A and FIG. 4B, below. If operation 306 does not invoke the navigation agent, flow 300 proceeds to operation 312, described below.

Operation 310 when executed by at least one processor causes one or more computing devices to present the selected navigation elements to the user and/or present search results, in response to the search query, via the user interface through which the search session was initiated. In doing so, operation 310 may dynamically display or re-configure one or more selected navigation elements and/or search results on a graphical user interface portion of the user interface, and/or output computer-generated conversational speech via a speaker (for example, an integrated speaker of a mobile device or other form of computing device). As noted above, for ease of discussion, the term “navigation elements” may refer, individually or collectively, to any form of computer-generated navigational assistance provided to a user, including but not limited to re-formulated searches, filter elements, conversational speech elements, and informational content elements. Presentation of one or more search results also may be considered a navigation element or may be included in one or more navigation elements.

Operation 312 when executed by at least one processor causes one or more computing devices to determine whether the search session detected in operation 302 has ended. To do this, operation 312 may process the user state data extracted from the search session by operation 304 to determine if, for example, a web page or mobile application displaying the user interface has been closed. Alternatively, operation 312 may measure the time interval between successive queries or successive user activities in a temporal sequence of user activities, and determine that the search session has ended if the time interval exceeds a threshold duration, such as n minutes, where n is a positive integer). If operation 312 determines that the search session has ended, flow 300 proceeds to operation 314. If operation 312 determines that the search session has not ended, flow 300 proceeds to operation 316.

Operation 314 when executed by at least one processor causes one or more computing devices to extract additional user state data from the search session. Whereas operation 304 extracts user state data collected at timestamps occurring before presentation of selected navigation elements by operation 310, the additional user state data extracted by operation 314 has timestamps occurring after the presentation of selected navigation elements by operation 310. The additional user state data extracted by operation 314 is fed back to the navigation agent. The navigation agent then re-generates navigation element options, re-computes reward scores, and re-selects navigation elements via operation 308 using as inputs the additional user state data.

Operation 316 when executed by at least one processor causes one or more computing devices to store, in computer memory such as reference data store 150, session data, including user state data and reward scores, for example, and to update one or more machine learning models, such as reinforcement learning models, used by the navigation agent.

### Example Search Session

FIG. 3B is a simplified flow diagram of an embodiment of software-based components and operations that can be performed by at least one device of a computing system such as system 100. The components and operations of a flow 350 as shown in FIG. 3B can be implemented using processor-executable instructions that are stored in computer memory. For purposes of providing a clear example, the components of FIG. 3B are described as performed by computing system 100, but other embodiments may use other systems, devices, or implemented techniques.

FIG. 3B illustrates an example of a session. A session may start, for example, when the user enters a query and remains active until he/she terminates their micro (on the same device) or macro (across devices) search session by either closing the page or by not interacting with the page for a set long period of time.

In FIG. 3B, a user state, {State}, at a particular timestamp includes historical user state data 352, a current search query and filters, if any 354, and output produced by a natural language query parser 356. Historical user state data 352 includes, for example, historical user activity data, user activity data, e.g., user interactions and actions, for the user's current session, and user preferences. Examples of historical user activity data include user state data collected during prior search sessions of the user. Examples of user activity data collected during the user's current session include user-initiated interactions with a search interface, such as clicks, taps, and text input. Examples of user preferences include likes, follows, shares, and forwards of content.

Other data that may be incorporated into a {State} include: aggregate activity of users (e.g., percentage of users over a historical time period who have clicked on search results returned for the same query); each navigation component or sub-component's option selections and the corresponding confidence scores (where a navigation sub-component, such as the filter recommendation component, may be a supervised model); a semantic representation of the user's query (e.g., an intent) and corresponding confidence score, if the semantic representation is model-generated.

Natural language query parser 356 parses current search query and filters 354 into re-formulated search choices, if any 358, semantic representation of the query 357, and filter choices, if any 360. Examples of re-formulated search choices 358 include computer-generated re-formulated search choices that were generated by RL agent 364 during a previous state, presented to the user, and indications of whether any of the choices were selected or not selected by the user. Examples of filter choices 360 include computer-generated filter choices that were generated by RL agent 364 during a previous state, presented to the user, and indications of whether any of the choices were selected or not selected by the user.

An example of a semantic representation of the query 357 is a parameterized semantic interpretation of an unstructured natural language portion of a search query, such as an intent and slots; for instance, Job_Title(“software engineer”) if the search query contained the phrase “software engineer.” Natural language query parser 356 can be implemented using, for example, a LUCENE query parser. In general, a semantic parser can be implemented using a rules engine or a statistical model, or a combination of rules and statistical modeling. Examples of intents and slots are described in greater detail above.

RL agent 364 is a reinforcement learning-based navigation agent, such as RL-based navigation agent 212, described above. RL agent 364 encapsulates the user's past and current activity into {State} before selecting and causing execution of one or more actions, {Actions}. RL agent 364 computes one or more reward scores using {Reward Signals}, which include implicit and/or explicit user feedback 362.

Different instances of user feedback 362 may be assigned different reward values. An example of one of the many possible reward formulations includes, but is not limited to:

+10—user's goal has been achieved (e.g., Sending a message to a potential candidate for a job indicates a successful search session for a recruiter who is looking for most relevant candidates for an open role).

+1—user's goal has been partially achieved (e.g., user clicks on the member profile but does not send a message)

0—user's goal has not been achieved, but session is still active (e.g., user refines the query with additional filters, but does not click on any search result or navigation suggestions).

−1—user's goal has not been achieved, and session has ended (e.g., user closes the search session/page without clicking on either search results or navigation suggestions).

RL Agent 364 selects the one or more actions to be executed in response to a given user state based on the one or more reward scores that it has computed using the reward signals. For purposes of this disclosure, user feedback 362 may be considered as a component of user state data. Thus, references to user state data herein may include portions of user feedback 362. Examples of {Actions} that may be selected by RL Agent 364 at any given {State} in response to {Reward Signals} include display search results 366, perform conversational disambiguation 368, display one or more re-formulated searches 370, display training material 372, and display one or more filter(s) 374. The {Actions} shown in FIG. 3B correspond to computer-generated navigation options described above, but are not limited to the options shown. Any combination of the options shown and/or other navigation options may be included in the set of {Actions} depending on the requirements of a particular implementation.

In more detail, examples of {Actions} include, but are not limited to:

Show search results. May be selected by the navigation agent if the confidence score associated with the search results satisfies a high confidence score threshold, which may be determined based on the requirements of a particular design of the system. In general, confidence values are generated by the search engine as part of the process of executing a search query. A confidence value assigned to a search result quantifies the degree to which the search result matches the search query. A confidence value may be based on, for example, the number of occurrences of search terms in the search result.

Show search results and re-formulated search choices—May be selected by the navigation agent if the confidence score associated with the search results satisfies an intermediate confidence score threshold, where the intermediate threshold is lower than the high threshold. In this case, the navigation agent generates and provides re-formulated search choices along with the search results. Re-formulated search choices are natural language, free form queries generated by training a model on consecutive queries users enter within a search session. A re-formulated search can facilitate query expansion (e.g., ‘also try’ and ‘did you mean . . . ’ suggestions).

Show re-formulated search options—May be selected by the navigation agent if the confidence score associated with the search results does not satisfy the intermediate confidence score threshold; results in the presentation of alternate reformulations of the original search query without showing any search results.

Show search results and show additional filter choices—May be selected by the navigation agent if the confidence score associated with the search results does satisfy the intermediate confidence score threshold but not the high threshold; results in the presentation of additional filter options to refine the query. Filter choices help refine the query further and provide a way for the users to specify fine-grained search criteria. In comparison to reformulated search choices, filter choices may be based on taxonomy of pre-determined values for a given filter category (e.g., different predetermined list of skills for the skill filter).

Show query refinement suggestions using filters—May be selected by the navigation agent if the confidence score associated with the search results does not satisfy the intermediate confidence score threshold; results in presentation of additional filters to improve the accuracy of returned results for a given search query.

Show search results, re-formulated search choices and filter choices—May be selected by the navigation agent if the confidence score associated with the search results does satisfy the intermediate confidence score threshold but the user has been determined to be a new user or the reward scores associated with the re-formulated searches and filter options are higher than corresponding thresholds.

Invoke conversational disambiguation—A navigation option, such as a filter choice to refine the query, can be presented as a natural language conversation. For example, the navigation agent may initiate a “slot elicitation” action (term), where the agent generates and presents a conversational natural language dialog element to the user that asks the user to provide missing information in order to fill one or more slots of an intent. Similarly, the navigation assistant may generate and present conversational natural language dialog elements that ask the user to refine the query or which provide helpful suggestions in a conversational style. The sequence of actions generated by the navigation agent is determined based on the configuration of the RL algorithm that samples the actions during training and optimizes them over time to maximize long term reward. This is one of the strengths of using RL over supervised learning, which is to provide better exploration over the action space.

Coaching videos or help suggestions on how to use the search interface—May be selected by the navigation agent if the user has been determined to be a new user or the reward scores associated with the coaching videos or help suggestions are higher than corresponding thresholds.

No-action—May be selected by the navigation agent if the user has been determined to be a power user or no re-formulated search choices or filter choices have reward scores that exceed the corresponding threshold.

### Example Query Re-Formulation Process

FIG. 4A is a simplified flow diagram of an embodiment of operations that can be performed by at least one device of a computing system. The operations of a flow 400 as shown in FIG. 4A can be implemented using processor-executable instructions that are stored in computer memory. For purposes of providing a clear example, the operations of FIG. 4A are described as performed by computing system 100, but other embodiments may use other systems, devices, or implemented techniques.

Operation 402 when executed by at least one processor causes one or more computing devices to determine search query data and user state data. To do this, operation 402 may extract the search query data and user state data from a search session. In an embodiment, user state data can be represented as a trajectory of queries and reward scores that occur sequentially during a search session, for example: [q₀, q₁, r₁, q₂, r₂, q₃, r₃, q₄, r₄], where q₀ is the initial source query input by a user, as an initial user state s₀, which started the search session.

Subsequently, the user may either input a new query or click through a subsequent query q₁ (such as a re-formulated search seen by the system 100 as an action a₀) at which time the user's state transitions to s₁. An immediate reward score r₁ is computed right after q₁ and before any further action is taken; that is, before any search results are presented. Subsequently, the user may go on to input or click through a new query q₂, and a similar process repeats until the end of the search session is reached. At each time step t, pairs of (state, action) are collected as (qₜ₋₁, qₜ), t=1 . . . T, and these pairs are used to calculate the cumulative long-term reward as described below.

Operation 404 when executed by at least one processor causes one or more computing devices to generate candidate re-formulated searches. In an embodiment, candidate re-formulated searches are computer-generated queries that are re-formulations of a source query, where a source query is for example a query entered by a user into a search interface. To generate re-formulated search options, in some embodiments, operation 404 may use a supervised sequence to sequence encoder-decoder recurrent neural network (RNN)-based machine learning model initialized using MLE (maximum likelihood estimate) parameters and tuned using a policy gradient approach, such as REINFORCE Monte-Carlo Policy Gradient algorithm, to find parameters that lead to a larger expected long-term reward. An example configuration of an RNN-based model that may be used in the implementation of FIG. 4A is shown in FIG. 2C, described above.

Operation 406 when executed by at least one processor causes one or more computing devices to compute reward scores for each search re-formulation option. In an embodiment, a final reward score is computed as a linear combination of multiple alternative reward scores that measure, for example, user engagement, syntactic similarity of the search re-formulation option to the source query, and/or other factors, using a formula such as

r=Σ^{N}ᵢ₌ₜλᵢ*rᵢ, where N is the number of individual reward scores and lambda is a weight value assigned to the individual reward score rᵢ. The weight value, lambda, is set to reflect the relative importance of the corresponding reward score; and may be a value between 0 and 1. Lambda values may be initialized for example manually and then tuned using, for example, a Bayesian optimization method. Lambda values may be set as hyperparameters. In some embodiments, N=6, meaning that the final reward score for a re-formulated search option is a combination of 6 alternative reward scores. For example, the final reward score may be a weighted sum of the alternative reward scores or a weighted average of the alternative reward scores.

In some embodiments, a first reward score, r₁, may capture user engagement while the user is interacting with application software 170 or search engine 160 in a search session, using a formula such as: r₁=Σ^{T}ᵢ₌ₜγ^{T-t}cᵢ, where T is the temporal length of the search session, t is a particular time step within the search session, and cᵢ is an occurrence of user engagement; for example, a user click on a search result or navigation element, within the search session.

Other examples of reward scores include, for example, r₂ and r₃, which each measure syntactic similarity of a re-formulated search option candidate with the source query using a different similarity metric. Examples of similarity metrics that may be used to compute r₂ and r₃ include but are not limited to the Jaccard similarity score and the BLEU (bilingual evaluation understudy) similarity score. Other suitable reward scores include r₄, which measures semantic similarity between a re-formulated search option candidate and the source query by, for example, measuring the similarity between semantic embeddings of the re-formulated search option candidate and the source query. A semantic embedding may be created using, for example, WORD2VEC.

Still another reward score that may be used to compute r is r₅, which measures the “naturalness” of a re-formulated search option candidate. Naturalness indicates a probability that a re-formulated search option candidate corresponds to natural language that has a high probability of being something that a human user would likely input. In an embodiment, naturalness is determined using a machine learning-based classification model that has been trained with search queries entered by a population of users. In an embodiment, the naturalness model is implemented using reinforcement learning to enable the naturalness model to be updated based on user feedback.

Yet another reward score that may be used to compute r is r₆, which is a probability of the system generating the re-formulated search option candidate given the source query. Other factors that may contribute to the success of a search session led by a re-formulated search candidate and may be incorporated into the reward function include but are not limited to semantic coherence, diversity, and time to success (TTS).

Semantic coherence compares the mutual information and cosine similarity between a re-formulated search option candidate and a source query to see if the re-formulated search option candidate is grammatically coherent in comparison to the source query. Diversity measures the number of distinct terms in a re-formulated search option candidate with respect to the total length of the re-formulated search option candidate. Incorporating a diversity measurement into the reward function for re-formulated search option options reduces the likelihood of the system choosing a repetitive utterance as a re-formulated search candidate. TTS defines a timestamp at which a search session becomes valuable (or productive) for the user, and reflects the speed at which a user-desired result is achieved during the session. More specifically, TTS measures the time elapsed from a session start time to the first success event, where time may be measured, for example, in seconds.

Operation 408 when executed by at least one processor causes one or more computing devices to select one or more re-formulated searches based on the reward scores computed in operation 406. In an embodiment, a reinforcement learning agent selects the one or more re-formulated searches after having been trained on sequences of user state data extracted from search sessions of a population of users. Having been trained on the sequences of user state data for the population of users, the reinforcement learning agent determines which re-formulated search actions have the highest probability of generating positive user feedback in the form of, for example, high quality engagement or reduced time to success.

### Example Filter Process

FIG. 4B is a simplified flow diagram of an embodiment of operations that can be performed by at least one device of a computing system. The operations of a flow 450 as shown in FIG. 4B can be implemented using processor-executable instructions that are stored in computer memory. For purposes of providing a clear example, the operations of FIG. 4B are described as performed by computing system 100, but other embodiments may use other systems, devices, or implemented techniques. An example of a configuration of an RL agent that may be used to implement flow 450 is shown in FIG. 2D, FIG. 2E, and FIG. 2F, described above.

In an embodiment, flow 450 is triggered by a user selection of at least one filter entity, i.e., a source entity, thereby signaling the start of a new search session. Filter entities are data values, such as keywords or dates, that correspond to a facet and may be used to broaden or narrow a search query. A facet is a term that may be used to refer to a category of filter entities. For example, “Location” is an example of a facet, and “Bay Area” is an example of a filter entity associated with the “Location” facet. Each facet has a set of filter entities that are pre-defined according to the requirements of a particular implementation. As used herein, a “filter element” may refer to either a facet type or a filter entity, or both. That is, embodiments of system 100 can use the disclosed technologies to dynamically configure facet types that are presented to the user, filter entity options, or both facet types and filter entity options.

Operation 452 when executed by at least one processor causes one or more computing devices to determine and extract entity data for one or more user-selected filter elements, and user state data at the timestamp of the user selection. Optionally, operation 452 may extract user metadata such as user profile data. Operation 454 when executed by at least one processor causes one or more computing devices to generate a set of candidate filter elements based on the user state data and filter element data obtained by operation 452.

To do this, operation 454 may compute a semantic similarity score between the user-selected filter element and each candidate filter element, using semantic embeddings. Operation 454 may then retrieve the top K candidate filter elements whose similarity scores exceed a threshold score that is determined based on the requirements of the particular implementation, where K is, for example, a positive integer. User state data collected for filter element options is similar to the trajectory described above for re-formulated searches but also includes, for each query, the newly selected filter element et (if any), where t is the timestamp of the associated query. User activities applicable to filter element options may include the above-mentioned user activities.

Operation 456 when executed by at least one processor causes one or more computing devices to compute reward scores for candidate filter elements determined by operation 454. In an embodiment, a reward score for a candidate filter element is computed as the dot product between the action weight vector a and the entity embedding e. The candidate filter elements are sampled; that is, each candidate filter element has a different probability of success.

Operation 458 when executed by at least one processor causes one or more computing devices to select filters based on the reward scores computed in operation 456. In an embodiment, a reinforcement learning agent computes a reward score r, given a user state s and a system action a (e.g., presentation of a filter element), based on subsequent user state data indicating user feedback such as click, negate, not click, send message, save the recommended filter, etc. A discount parameter γ measures the present value of future rewards, where a future reward is a reward score computed for a subsequent user state, for example. When γ=0, the reinforcement learning agent only considers immediate rewards, e.g., rewards computed using feedback received only on the current state sₜ and ignores long term rewards, e.g., reward scores computed using feedback received over the course of the entire session. When γ=1, long term rewards are considered as equally important as immediate rewards. Within a search session, rewards may be defined as positive integers indicating the relative significance of various user activities, for instance, r=0 if the recommended entity is not clicked, r=1 if the recommended entity is clicked, r=2 if a positive subsequent action is detected, such as sending a message, viewing a user profile, etc. To select a filter, a deterministic policy gradient algorithm may be used; for example, a deep deterministic policy gradient algorithm (DDPG). FIG. 2F, described above, shows an example of a DDPG algorithm that may be used in operation 458.

The reinforcement learning-based approach to dynamically generating filter element options enables the system 100 to adapt to changes in user behavior and respond differently to different types of queries. For example, once a user selects a filter element, the system 100 dynamically determines one or more additional filters to display and/or an order of arrangement on a display, and automatically refines other candidate filters based on the user state data prior to the presentation of the filter and subsequent user state data (feedback).

### User Interface Examples

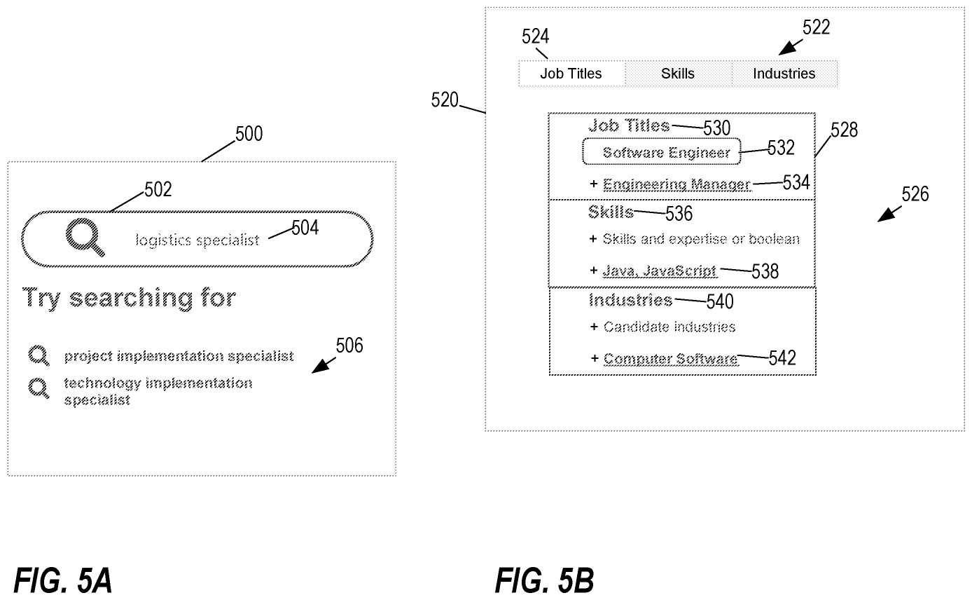

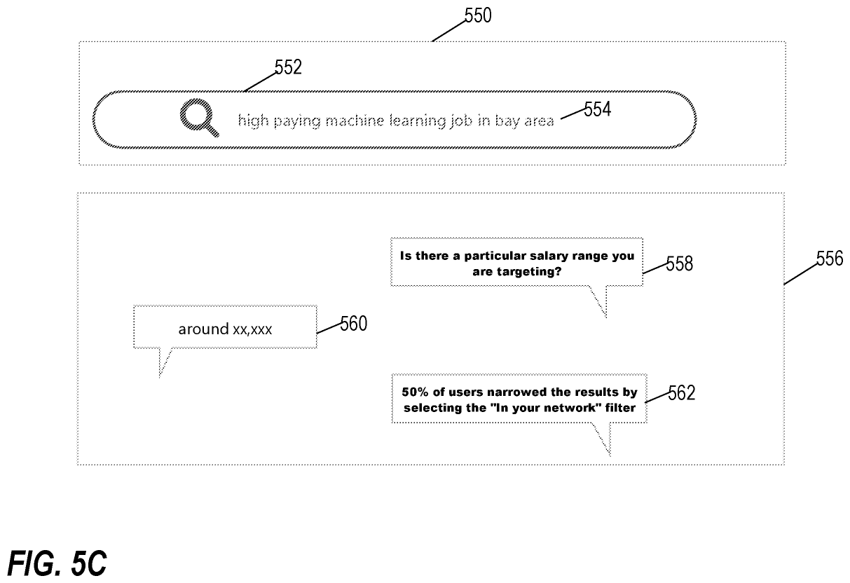

FIG. 5A, FIG. 5B, and FIG. 5C are example screen captures of navigation elements that may be displayed on a display device and/or output by a speech/audio subsystem of at least one embodiment of the computing system of FIG. 1. For example, user interfaces such as those shown in FIG. 5A, FIG. 5B, and FIG. 5C may be provided to user interface 112.

FIG. 5A illustrates an example of a user interface panel 500. Panel 500 includes a search input box 502 and a set of re-formulated searches 506. Search input box 502 contains a search query 504, which is a natural language query that has been entered into search input box 502 by a user. Re-formulated searches 506 have been identified in response to search query 504, based on user state data and reward scores, using the reinforcement learning-based processes described above; for example, flow 400.

FIG. 5B shows an example of a user interface panel 520 that may be presented to a system-determined “new user.” Whereas panel 520 may not be displayed at all for a system-determined “power user,” for the new user, panel 520 includes a set of facets 522 and a set of filter panels 526. As described above, system 100 may determine whether a user is “new” or a “power” user by comparing the timestamp of the user's account creation date to the timestamp of the current session, for example. The set of facets 522 and/or the set of filter panels 526 and/or their particular arrangement on panel 520 are dynamically generated or re-configured based on user state data and reward scores, using the reinforcement learning-based processes described above; for example, flow 450.

In FIG. 5B, the user has selected the Job Titles facet 524. In response to the user selection of facet 524, using the disclosed technologies, system 100 configures the set of filter panels 526 to show the Job Titles panel 528 at the top, above Skills 536 and Industries 540. Additionally, using the disclosed technologies, in response to user selection of entity 532, system 100 has dynamically generated and displayed within-facet entity options 532, 534 as well as cross-facet entity options 538 and 542.

FIG. 5C shows an example of a user interface that includes panel 550 and panel 556. Panel 550 includes a search input box 552. A user has entered a natural language search query 554 into the search input box. Using the disclosed reinforcement learning technologies, system 100 may determine that search query 554 has a low probability of generating desired search results because, for example, “high paying” has been determined ambiguous by a semantic parser.

System 100 also has determined that conversational navigation elements have a higher probability of leading to a positive user experience for this particular user than other navigation options. To do this, system 100 may have processed user metadata and determined, based on a comparison of user account creation timestamp to a session timestamp, that the user is a new user. As a result, system 100 presents navigation elements in the form of conversational prompts, such as natural language sentences or questions, via dialog balloons 558, 562.

Dialog balloon 558 presents a computer-generated conversational natural language sentence or question configured to clarify the ambiguous nature of “high paying.” The user responds with a salary range in dialog balloon 560. System 100 adds the user's salary figure as a filter element. Dialog balloon 562 presents a filter. Dialog balloons 558, 562 are dynamically configured based on the cumulative user state data collected during the search session. Dialog balloons 558, 562 may be implemented using an asynchronous text messaging interface or a voice/speech-based interface, for example. To generate conversational natural language dialog elements, system 100 may use, for example, templates that specify the grammatical structure of the natural language output, and text-to-speech (TTS) software.

In the example of FIG. 5C, two RL-based navigation agents are used: an RL-based navigation sub-agent is used to generate filter options and to select the “salary range” filter option to present as a choice to the user. A ‘top-level’ RL-based navigation agent is used to select conversational disambiguation over graphical presentation of the filter element.

### Example Hardware Architecture

According to one embodiment, the techniques described herein are implemented by at least one special-purpose computing device. The special-purpose computing device may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, mobile computing devices, wearable devices, networking devices or any other device that incorporates hard-wired and/or program logic to implement the techniques.

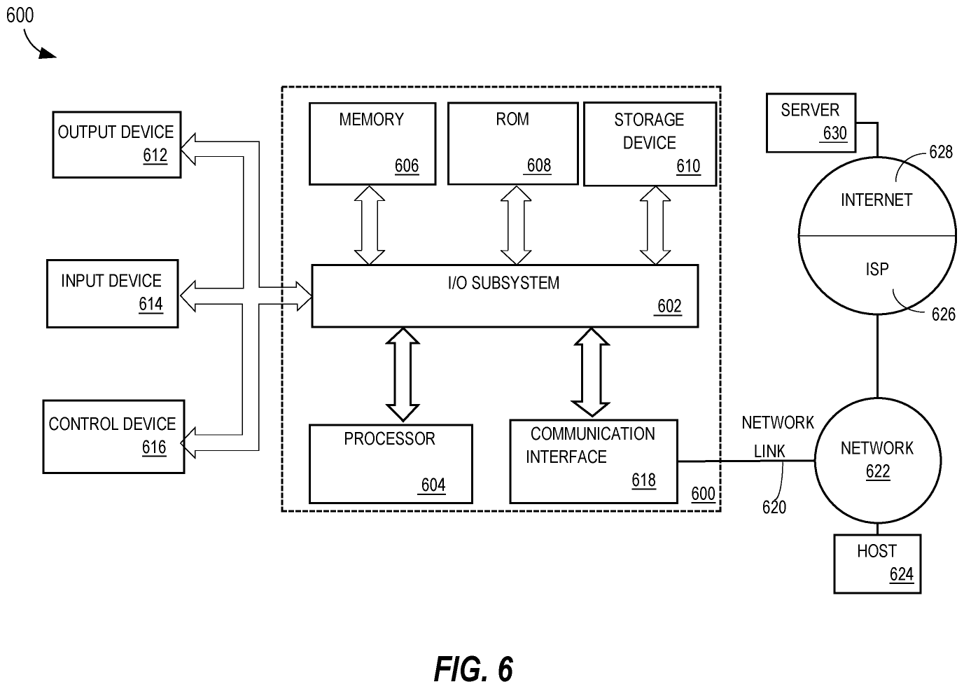

For example, FIG. 6 is a block diagram that illustrates a computer system 600 upon which an embodiment of the present invention may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory computer-readable storage media accessible to processor 604, render computer system 600 into a special-purpose machine that is customized to perform the operations specified in the instructions.

Computer system 600 and further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to an output device 612, such as a display, such as an liquid crystal display (LCD) or a touchscreen display, for displaying information to a computer user, or a speaker, a haptic device, or another form of output device. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, at least one ASIC or FPGA, firmware and/or program logic which in combination with the computer system causes or programs computer system 600 to be a special-purpose machine. According to one embodiment, the techniques herein are performed by computer system 600 in response to processor 604 executing at least one sequence of instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying at least one sequence of instruction to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated-services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through at least one network to other data devices. For example, network link 620 may provide a connection through local network 622 to a host computer 624 or to data equipment operated by an Internet Service Provider (ISP) 626. ISP 626 in turn provides data communication services through the world-wide packet data communication network commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 530 might transmit a requested code for an application program through Internet 628, ISP 626, local network 622 and communication interface 618. The received code may be executed by processor 604 as it is received, and/or stored in storage device 610, or other non-volatile storage for later execution.

### Additional Examples

Illustrative examples of the technologies disclosed herein are provided below. An embodiment of the technologies may include any of the examples or a combination of the described below.

In an example 1, a method includes inputting digital data including search query data and a sequence of user state data into at least one reinforcement learning model; the search query data obtained for a search query received via an input device during a session; the sequence of user state data containing user state data extracted from the session before search results are presented in response to the search query; producing, by the at least one reinforcement learning model, at least two reward scores; the at least two reward scores computed by the at least one reinforcement learning model, using the user state data, for at least two navigation elements of a plurality of computer-generated navigation element options; using the at least two reward scores, selecting, by the at least one reinforcement learning model, at least one navigation element of the plurality of computer-generated navigation element options; in response to the search query, outputting the selected at least one navigation element for presentation via an output device operably coupled to the input device; where the method is performed by at least one computing device.

An example 2 includes the subject matter of example 1, further including updating the sequence of user state data to include additional user state data extracted from the session after the at least one navigation element of the plurality of computer-generated navigation element options has been output, and receiving, from the at least one reinforcement learning model, a re-computed set of reward scores computed using the additional user state data.

An example 3 includes the subject matter of example 1 or example 2, further including, using the at least two reward scores, selecting, by the reinforcement learning model, at least one search filter of a set of computer-generated optional search filters and outputting the selected at least one search filter for presentation in response to the search query. An example 4 includes the subject matter of any of examples 1-3, further including, using the at least two reward scores, selecting, by the reinforcement learning model, at least one re-formulated search of a set of computer-generated re-formulated searches and outputting the selected re-formulated search for presentation in response to the search query. An example 5 includes the subject matter of any of examples 1-4, further including, using the at least two reward scores, selecting, by the reinforcement learning model, at least one conversational navigation element of a set of computer-generated conversational natural language navigation elements and outputting the selected at least one conversational navigation element for output in response to the search query. An example 6 includes the subject matter of any of examples 1-5, the at least one reinforcement learning model trained using population state data indicating sequences of states of a population of users after presentations of computer-generated optional navigation elements to the population of users in response to natural language search queries received from the population of users during sessions of the population of users. An example 7 includes the subject matter of any of examples 1-6, the session including a temporal sequence of user activities including at least one user activity involving a search engine and at least one user activity involving a connections network-based system.

In an example 8, at least one or more non-transitory computer-readable storage media including instructions which, when executed by at least one processor, cause the at least one processor to be capable of performing operations including: inputting digital data including search query data and a sequence of user state data into a reinforcement learning model; the sequence of user state data extracted from a session; the search query data obtained for a search query received via an input device during the session; the reinforcement learning model trained using population state data; the population state data indicating sequences of states of a population of users after presentations of computer-generated re-formulated searches to the population of users in response to search queries received from the population of users during sessions of the population of users; computing, by the reinforcement learning model, at least two reward scores for at least two computer-generated re-formulated search options; using the at least two reward scores, selecting, by the reinforcement learning model, at least one re-formulated search of the at least two computer-generated re-formulated search options; outputting the selected at least one re-formulated search for presentation in response to the search query via an output device operably coupled to the input device.

An example 9 includes the subject matter of example 8, where the instructions further cause computing, as a reward score of the at least two reward scores, a probability that a re-formulated search of the computer-generated re-formulated searches corresponds to a natural language sentence. An example 10 includes the subject matter of example 8 or example 9, where the instructions further cause computing, as a reward score of the at least two reward scores, a measurement of semantic similarity between a re-formulated search of the computer-generated re-formulated searches and the search query data. An example 11 includes the subject matter of any of examples 8-10, where the instructions further cause computing, as a reward score of the at least two reward scores, a measurement of diversity of terms within a re-formulated search of the computer-generated re-formulated searches relative to a length of the re-formulated search. An example 12 includes the subject matter of any of examples 8-11, where the instructions further cause, using the sequence of user state data, computing, as a reward score of the at least two reward scores, a measurement of user engagement during the session. An example 13 includes the subject matter of any of examples 8-12, where the instructions further cause computing, as a reward score of the at least two reward scores, a measurement of syntactic similarity between the search query data and a re-formulated search of the computer-generated re-formulated searches. An example 14 includes the subject matter of any of examples 8-13, where the instructions further cause computing, as a reward score of the at least two reward scores, a difference between a start time of the session and a time of occurrence of a success event during the session. An example 15 includes the subject matter of any of examples 8-14, where the instructions further cause computing a final reward score as a weighted sum of reward scores of the set of reward scores, and selecting the at least one re-formulated search based on the final reward score.

In an example 16, a system includes: at least one processor; memory operably coupled to the at least one processor; instructions stored in the memory and capable of being executed by the at least one processor, the instructions including: a reinforcement learning-based agent configured to receive digital data extracted from a session that includes user interaction with a user interface of a search engine, the digital data including a search query and a sequence of user state data indicative of user interaction occurring prior to execution of the search query by the search engine; the reinforcement learning-based agent configured to, using the search query, generate a plurality of optional navigation elements capable of being presented by the user interface; the reinforcement learning-based agent configured to, using the search query, the sequence of user state data, and user feedback data received in response to previous presentations of navigation elements by the user interface, compute a plurality of reward scores for the plurality of optional navigation elements; the reinforcement learning-based agent configured to, using the plurality of reward scores, select a subset of the plurality of optional navigation elements for presentation by the user interface.

An example 17 includes the subject matter of example 16, where the reinforcement learning-based agent includes a reinforcement learning model trained using population state data indicating sequences of states of a population of users after presentations of computer-generated optional navigation elements to the population of users in response to search queries received from the population of users during sessions of the population of users. An example 18 includes the subject matter of example 16 or example 17, where the reinforcement learning-based agent includes a reinforcement learning model trained using a policy gradient method. An example 19 includes the subject matter of any of examples 16-18, where the system is communicatively coupled to the user interface of the search engine to provide the selected subset of the plurality of optional navigation elements to the user interface of the search engine. An example 20 includes the subject matter of any of examples 16-19, where the system is communicatively coupled to a user interface of an online network-based system to provide the selected subset of the plurality of optional navigation elements to the user interface of the online network-based system.

The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

As used herein the terms “include” and “comprise” (and variations of those terms, such as “including,” “includes,” “comprising,” “comprises,” “comprised” and the like) are intended to be inclusive and are not intended to exclude further features, components, integers or steps.

Various features of the disclosure have been described using process steps. The functionality/processing of a given process step potentially could be performed in different ways and by different systems or system modules. Furthermore, a given process step could be divided into multiple steps and/or multiple steps could be combined into a single step. Furthermore, the order of the steps can be changed without departing from the scope of the present disclosure.

It will be understood that the embodiments disclosed and defined in this specification extend to alternative combinations of the individual features mentioned or evident from the text or drawings. These different combinations constitute various alternative aspects of the embodiments.

What is claimed is:

1. A method, comprising:
inputting digital data including search query data and a sequence of user state data into at least one reinforcement learning model;
the search query data obtained for a search query received via an input device during a session;
the sequence of user state data containing user state data extracted from the session before search results are presented in response to the search query;
producing, by the at least one reinforcement learning model, at least two reward scores;
the at least two reward scores computed by the at least one reinforcement learning model, using the user state data, for at least two navigation elements of a plurality of computer-generated navigation element options;
using the at least two reward scores, selecting, by the at least one reinforcement learning model, at least one navigation element of the plurality of computer-generated navigation element options;
in response to the search query, outputting the selected at least one navigation element for presentation via an output device operably coupled to the input device;
wherein the method is performed by at least one computing device.

2. The method of claim 1, further comprising updating the sequence of user state data to include additional user state data extracted from the session after the at least one navigation element of the plurality of computer-generated navigation element options has been output, and receiving, from the at least one reinforcement learning model, a re-computed set of reward scores computed using the additional user state data.

3. The method of claim 1, further comprising, using the at least two reward scores, selecting, by the reinforcement learning model, at least one search filter of a set of computer-generated optional search filters and outputting the selected at least one search filter for presentation in response to the search query.

4. The method of claim 1, further comprising, using the at least two reward scores, selecting, by the reinforcement learning model, at least one re-formulated search of a set of computer-generated re-formulated searches and outputting the selected re-formulated search for presentation in response to the search query.

5. The method of claim 1, further comprising, using the at least two reward scores, selecting, by the reinforcement learning model, at least one conversational navigation element of a set of computer-generated conversational natural language navigation elements and outputting the selected at least one conversational navigation element for output in response to the search query.

6. The method of claim 1, the at least one reinforcement learning model trained using population state data indicating sequences of states of a population of users after presentations of computer-generated optional navigation elements to the population of users in response to natural language search queries received from the population of users during sessions of the population of users.

7. The method of claim 1, the session comprising a temporal sequence of user activities including at least one user activity involving a search engine and at least one user activity involving a connections network-based system.

8. At least one or more non-transitory computer-readable storage media comprising instructions which, when executed by at least one processor, cause the at least one processor to be capable of performing operations comprising:
inputting digital data including search query data and a sequence of user state data into a reinforcement learning model;
the sequence of user state data extracted from a session;
the search query data obtained for a search query received via an input device during the session;
the reinforcement learning model trained using population state data;
the population state data indicating sequences of states of a population of users after presentations of computer-generated re-formulated searches to the population of users in response to search queries received from the population of users during sessions of the population of users;
computing, by the reinforcement learning model, at least two reward scores for at least two computer-generated re-formulated search options;
using the at least two reward scores, selecting, by the reinforcement learning model, at least one re-formulated search of the at least two computer-generated re-formulated search options;
outputting the selected at least one re-formulated search for presentation in response to the search query via an output device operably coupled to the input device.

9. The at least one non-transitory computer-readable storage media of claim 8, wherein the instructions further cause computing, as a reward score of the at least two reward scores, a probability that a re-formulated search of the computer-generated re-formulated searches corresponds to a natural language sentence.

10. The at least one non-transitory computer-readable storage media of claim 8, wherein the instructions further cause computing, as a reward score of the at least two reward scores, a measurement of semantic similarity between a re-formulated search of the computer-generated re-formulated searches and the search query data.

11. The at least one non-transitory computer-readable storage media of claim 8, wherein the instructions further cause computing, as a reward score of the at least two reward scores, a measurement of diversity of terms within a re-formulated search of the computer-generated re-formulated searches relative to a length of the re-formulated search.

12. The at least one non-transitory computer-readable storage media of claim 8, wherein the instructions further cause, using the sequence of user state data, computing, as a reward score of the at least two reward scores, a measurement of user engagement during the session.

13. The at least one non-transitory computer-readable storage media of claim 8, wherein the instructions further cause computing, as a reward score of the at least two reward scores, a measurement of syntactic similarity between the search query data and a re-formulated search of the computer-generated re-formulated searches.

14. The at least one non-transitory computer-readable storage media of claim 8, wherein the instructions further cause computing, as a reward score of the at least two reward scores, a difference between a start time of the session and a time of occurrence of a success event during the session.

15. The at least one non-transitory computer-readable storage media of claim 9, wherein the instructions further cause computing a final reward score as a weighted sum of reward scores of the set of reward scores, and selecting the at least one re-formulated search based on the final reward score.

16. A system, comprising:
at least one processor;
memory operably coupled to the at least one processor;
instructions stored in the memory and capable of being executed by the at least one processor, the instructions comprising:
a reinforcement learning-based agent configured to receive digital data extracted from a session that includes user interaction with a user interface of a search engine, the digital data including a search query and a sequence of user state data indicative of user interaction occurring prior to execution of the search query by the search engine;
the reinforcement learning-based agent configured to, using the search query, generate a plurality of optional navigation elements capable of being presented by the user interface;
the reinforcement learning-based agent configured to, using the search query, the sequence of user state data, and user feedback data received in response to previous presentations of navigation elements by the user interface, compute a plurality of reward scores for the plurality of optional navigation elements;
the reinforcement learning-based agent configured to, using the plurality of reward scores, select a subset of the plurality of optional navigation elements for presentation by the user interface.

17. The system of claim 16, wherein the reinforcement learning-based agent comprises a reinforcement learning model trained using population state data indicating sequences of states of a population of users after presentations of computer-generated optional navigation elements to the population of users in response to search queries received from the population of users during sessions of the population of users.

18. The system of claim 16, wherein the reinforcement learning-based agent comprises a reinforcement learning model trained using a policy gradient method.

19. The system of claim 16, wherein the system is communicatively coupled to the user interface of the search engine to provide the selected subset of the plurality of optional navigation elements to the user interface of the search engine.

20. The system of claim 16, wherein the system is communicatively coupled to a user interface of an online network-based system to provide the selected subset of the plurality of optional navigation elements to the user interface of the online network-based system.
